(19) United States
(12) Patent Application Publication
(10) Pub. No.: US 2016/0033313 A1
(43) Pub. Date: Feb. 4, 2016

(54) MEASURING VELOCITY USING SUBSTANCE CHARACTERISTICS

(71) Applicant: International Business Machines Corporation, Armonk, NY (US)

(72) Inventors: Sean A. McKenna, Dublin (IE); Frank Suits, Garrison, NY (US)

(21) Appl. No.: 14/446,380

(22) Filed: Jul. 30, 2014

(51) Int. Cl. G01F 1/708; G01P 3/64

(52) U.S. Cl. CPC G01F 1/708; G01P 3/64

(57) ABSTRACT

A system for measuring velocity of a substance using data pattern characteristics. A computer receives a data set from a first location. A computer receives a second data set from second location. A computer determines that the second set of data is substantially similar to the first set of data, and calculates the velocity using both sets.

### FIELD OF THE INVENTION

The present invention generally relates to measuring velocity, and more particularly to utilizing substance characteristics to detect a time rate of change of position of a body in a given direction.

### BACKGROUND OF THE INVENTION

There are many applications where it is useful to measure velocity of a substance utilizing preexisting system instrumentation without installing velocity metering devices within a system. One such circumstance may include hazardous fluid transport processes, where installing new velocity measuring instrumentation may be impractical or detrimental to safety. For example, in a highly corrosive environment a velocity measurement device may have to be changed routinely due to degradation, in turn exposing maintenance personnel to possible hazards. In other examples, installation of new velocity measurement devices may not be readily possible due to location of the system, such as submerged marine piping or urban sewage systems.

### SUMMARY

Embodiments of the present invention disclose a method, computer program product, and system for measuring velocity of a substance using data pattern characteristics. A computer receives a first set of data, where the first set of data comprises one or more characteristics of a portion of a substance at a first location. The computer receives a second set of data, where the second set of data comprises one or more characteristics of at least a part of the portion of the substance at a second location. The computer determines that the second set of data is substantially similar to the first set of data and determines the velocity of the substance based on the first set of data and the second set of data.

### BRIEF DESCRIPTION OF THE SEVERAL VIEWS OF THE DRAWINGS

FIG. 1 is a schematic block diagram of a velocity measurement system, in accordance with an embodiment of the present invention.

FIGS. 2A, 2B, 2C, 2D, and 2E depict a graphical representation of correlation optimized warping, in accordance with an embodiment of the present invention.

FIGS. 3A and 3B depict a graphical representation of reference signatures before and after alignment, in accordance with an embodiment of the present invention.

FIG. 4 is a block diagram of internal and external components within the computing system of FIG. 1, in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in flowchart and/or the block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present invention provides a method for measuring velocity of a substance by utilizing characteristics of the substance within a conduit. A conduit may be described as any pipe, channel, or tube. Most industrial systems utilize a method for monitoring internal parameters of the conduit to promote efficiency, or safety. An example of such monitoring efforts may include utilization of: temperature, pressure, turbidity, or viscosity sensors within a conduit system. In hazardous applications, the installation of new sensing equipment may be disadvantageous due to safety concerns, economic impact of shutting the system down, inaccessibility, or cost of new equipment. Measuring velocity in most conduits often requires penetration of the pipe wall and insertion of measuring transducers or flow meters. Flow meters are popular because they give a direct measure of fluid velocity, the characteristic most commonly associated with flow rate within a system. These flow meters, however, are some of the most sensitive monitoring devices to process conditions. Since flow meters operate under the assumption of a constant velocity profile, they are inaccurate for flows in the laminar regime. Laminar flow occurs when a fluid flows in parallel layers, with no disruption between the layers. At low velocities the fluid tends to flow without lateral mixing, and adjacent layers slide past one another. This inaccuracy occurs because there is a large difference between the fluid velocity at the wall and at the center of the pipe. This property makes velocity meters especially sensitive to piping geometry and process conditions. In highly corrosive environments, such as saltwater piping, flow meters may have to be constantly maintained or replaced causing a lack of accurate readings. This installation oftentimes has associated labor costs that are greater than the cost of the meter itself. Other problems with such in-flow meters include the tendency for the meters to become clogged and calibration to deteriorate over time. It may be advantageous in such applications to utilize existing sensing equipment to measure velocity.

Some methods utilizing existing system sensors may use algorithmic time alignment of signals, as a processing step in velocity calculation. Dynamic time warping (DTW) is one method to measure velocity in limited applications, such as, open pipe sewage systems. DTW non-linearly expands and compresses signals in time by comparing the temporal distance of the first signal point sequence to that of the second point sequence. The result is a warping path that contains information on how to translate, compress and expand patterns so that similar features are matched. Dynamic time warping (DTW) may be too flexible for velocity estimates in conduits, resulting in an overcompensation of the observed shifts; thereby, suggesting unsuitability of this method for general industrial application. Shifting of the signal patterns in their entirety may provide inaccurate results and require additional data preparation. Even with pre-processed data and introduction of a tracer, velocity estimates calculated using DTW may furnish a significant error under industrial applications.

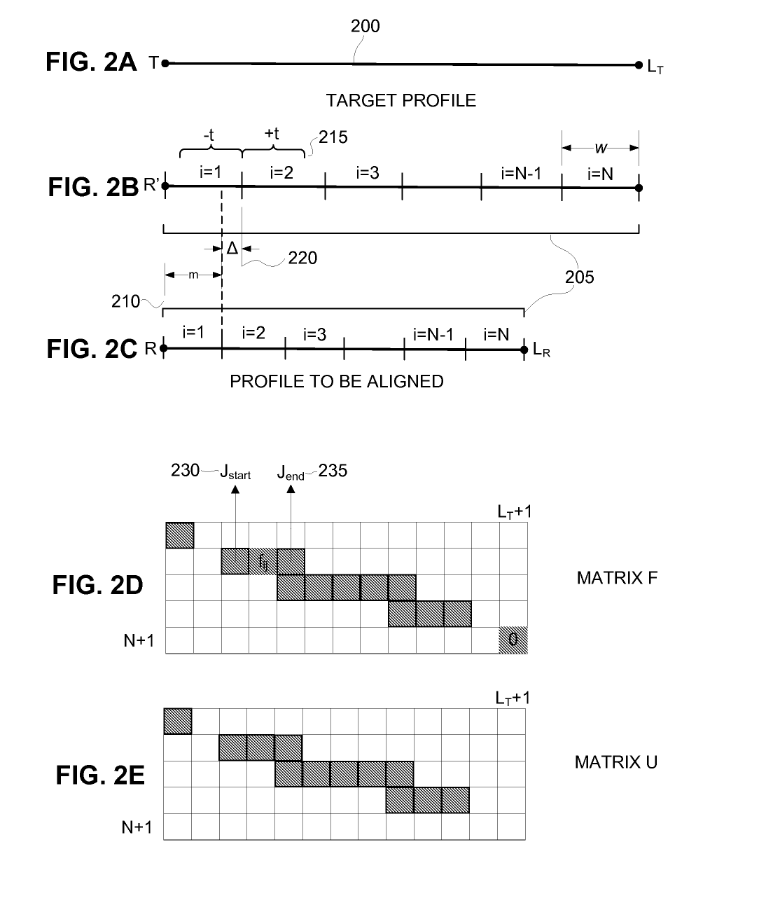

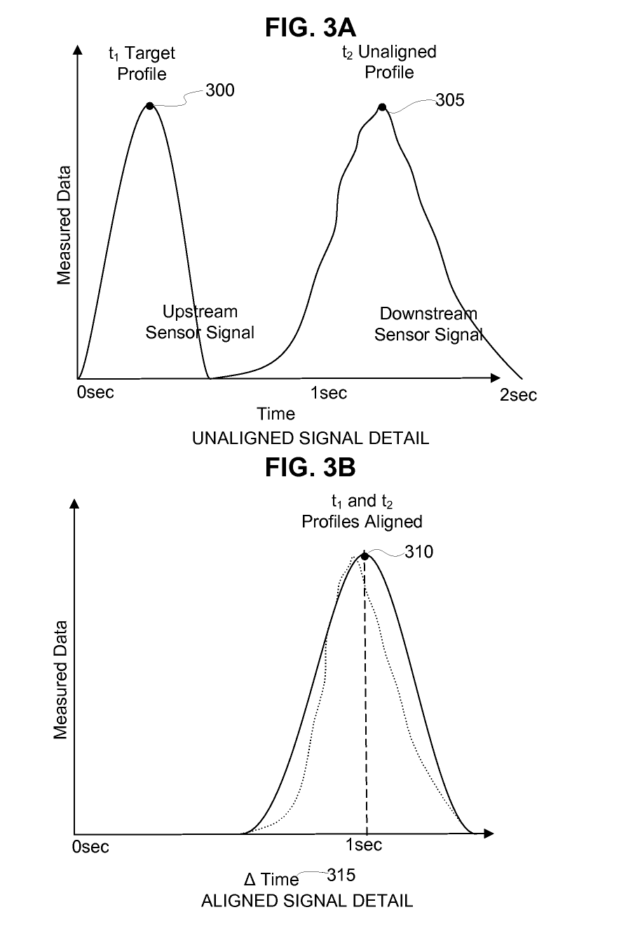

In contrast, correlation optimized warping (COW) is better suited for calculating velocity estimates. Correlation optimized warping (COW), unlike other methods, considerably simplifies the interpretation of the factor model results and yields more accurate results. To correct for misalignments or shifts in discrete data signals, COW uses small segments to improve results. It is a piecewise or segmented data preprocessing method (operating on one sample record at a time) aimed at aligning a sample data vector towards a reference vector by allowing limited changes in segment lengths on the sample vector. The COW process will be explained in further detail below with reference to FIGS. 2A, 2B, 2C, 2D, 2E, 3A, and 3B.

This method allows for greater accuracy without pre-processing data and/or introduction of foreign tracers. Tracer tests, where the introduction of a foreign tracer into the fluid as a measureable characteristic of the substance may be used to determine fluid velocity. A foreign tracer should be uniformly mixed to travel with the mean velocity of the fluid, it also may not introduce any artificial elements which can change the fluid's characteristics, such as velocity, density, solubility, or viscosity. Such tracers must also be easily measured by specific sensors within a system. The current approach employs background variations in a substance characteristic(s) as an ideal tracer and uses COW to determine velocity from these background variations.

Therefore, utilization of COW to calculate velocity by use of existing system sensing means, can answer the long felt need within industrial applications.

An embodiment of the invention may include two sensing locations within a velocity measuring system, where velocity may be measured by preexisting equipment by way of recording fluid (or substance) parameters within a conduit, then analyzing the data to correlate the readings, where the parameters may include any physical property that exhibits a deviating behavior.

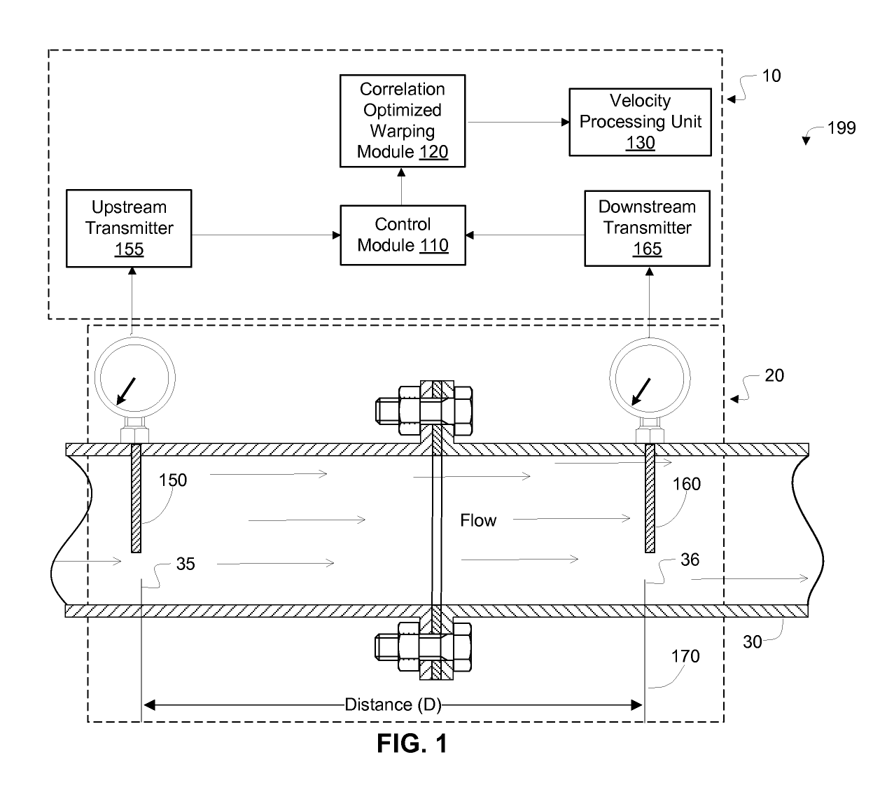

FIG. 1 is a schematic block diagram of a velocity measurement system 199, in accordance with an embodiment of the present invention. Velocity measurement system 199 includes a sensing section 20 along a pipe 30 and a velocity logic section 10. A known distance D used to measure the rate of change of the position of fluid within pipe 30 may be measured by two points. Two measurement points 35 and 36, located a distance D apart along the pipe 30, may be used as a starting point and ending point, respectively, for velocity calculations. Such measuring points may be located along preexisting sensing elements 150 and 160. Measuring point 35 may be located in a position that aligns with upstream sensing element 150, which may be capable of measuring fluid parameters such as temperature, or turbidity. The second measurement point 36 may be located in a position which aligns with the downstream sensing element 160, which is also capable of measuring the same fluid parameters as upstream sensing element 150 within pipe 30.

The sensing section 20 of velocity measuring system 199 is made up of a upstream sensing element 150 and downstream sensing element 160 separated by a known distance (D) 170 calculated from first measuring point 35 to second measuring point 36.

Sensing elements 150 and 160 may measure signal patterns of flow, fluid, or a substance having time varying properties that are manifested at least in part as changing characteristics within pipe 30. Such properties may be measured at two separate locations to determine time offset between them, in accordance with the embodiment of the present invention. These measured varying properties may have temporal and coherent length scales that differ from other characteristics within the fluid. Signal patterns of the fluid may be measured by preexisting sensing elements 150 and 160 and provide time based readings to upstream transmitter 155 and downstream transmitter 165 within velocity logic section 10. The measured substance may comprise one or more of liquids, gasses, slurry or other substances in a continuously connected phase between sensing elements 150 and 160, in accordance with an embodiment of the invention. Some or all of the functions within velocity logic section 10 may be implemented in software utilizing a computing device, or may be implemented using analog or digital hardware having sufficient parameters to perform the functions in accordance with an embodiment of the invention.

Upstream transmitter 155, and downstream transmitter 165, connected to control module 110 within velocity logic section 10, may receive a set of substance characteristics data from sensing elements 150 and 160. Both transmitters 155 and 165 may amplify and condition the signal patterns prior to sending it to control module 110. It is important to note that transmitters 155 and 165 are an exemplary embodiment and are not required to implement the invention.

Correlation optimized warping module 120 may receive signal patterns from control module 110, and analyze them to identify similar patterns within two distinct signals. Once two distinct but similar signals are determined, correlation optimized warping module 120 may then correlate the distinctive times of each pattern. Using distinct time for each pattern, correlation optimized warping module 120 may calculate the time it took the substance to travel from upstream sensing element 150 to downstream sensing element 160. For example, time delay may be described as the time it takes a specific substance characteristic to travel a known distance between the upstream sensing element 150 and an upstream sensing element 160 along known distance (D) 170 starting at measuring point 35 and ending at measuring point 36.

A graphical representation of time delay is illustrated in FIG. 3A. Two different signal patterns, t₁ and t₂, are depicted along a time scale. As an exemplary embodiment, t₁ target profile 300 may represent a signal recorded at 0.5 seconds by the upstream sensing element 150. In comparison, t₂ unaligned profile 305 may represent a second signal recorded at 1.5 seconds by the downstream sensing element 160. FIG. 3B, depicts the two signal patterns after a time shift with a time delay scale 315. Correlation optimized warping module 120 may shift signal patterns into a single time shift point 310, replacing the time scale with a time delay scale (ΔT). The time delay in FIG. 3B, is depicted as 1 second, representing the time delay (ΔT) it takes a specific substance characteristic data to travel from one measurement point 35 to the second measurement point 36.

A distance D between the measurement points 35 and 36 is divided by the time delay (ΔT) it takes a signal pattern to travel from upstream sensing element 150 to downstream sensing element 160 within pipe 30 to determine fluid velocity. Assuming, as an example, that the conduit measured is a pipe of equal diameter carrying incompressible fluid at a constant temperature, the velocity of the fluid can be described as:

Velocity (V)=Distance (D)/ΔT Eq. 1

In certain applications, the fluid velocity can be converted to volumetric flow rates, where:

Volumetric Flow Rate (Q)=V(Cross-Sectional Vector Area (A)) Eq. 2

Although the embodiments of the invention described herein are directed to flow of water through an equal diameter pipe, it will be appreciated by those of skill in the art that these embodiments are not limited to only this application, but instead can be practiced with all forms of transport processes, including but not limited to, gasses, curved piping, open channels and turbulent flows.

Referring to FIGS. 2A, 2B, 2C, 2D, 2E, correlation optimized warping may be used to determine the time delay (ΔT) between two sensing elements 150 and 160 separated by distance (D) 170, where the signals may be indicative of measured parameters (e.g. temperature, pressure, turbidity, or viscosity). Correlation optimized warping aligns two signals by piecewise linear stretching and compression. The optimal alignment is determined by correlation of the aligned fragments of signals.

FIG. 2A, represents a target profile signal T 200 of temporal length L_{T} as recorded by an upstream sensing element 150 within pipe 30.

In contrast, FIG. 2C represents R profile, the unaligned profile of the second signal recorded by the downstream sensing element 160 within pipe 30. The unaligned profile displays a much shorter temporal length (L_{R}) than target profile signal T 200 (FIG. 2A). In order to perform the time shift, both profiles' temporal lengths must be warped. As an exemplary embodiment, correlation optimized warping may divide both profiles into numbered section, as shown by unwarped section (m), 210 in accordance with the embodiment of the invention. R profile as shown in FIG. 2C, also depicts a total number of sections 205 used to segment both warped profile R′ (FIG. 2B) and R profile (FIG. 2C).

FIG. 2B, represents both signals T and R warped into a single profile R′. As an example a target profile (T) 200 length L_{T} may be divided into sections (N), where each section is denoted as w, and is warped by linear interpolation, so that signal R′ matches the length of target profile (T) 200.

The distances w and m define the section lengths for the target profile and the unaligned signal. The deviation between section lengths Δ 220 (FIG. 2C) between target profile (T) 200 (FIG. 2A) and the unaligned profile (R) 205 (FIG. 2C) is:

Δ=(L_{T}/N)−m Eq. 3

Range of possible warping (u) is determined by the input integer (t) that expresses maximum warping 215, thereby warping may be expressed as;

uₘₐₓ=[Δ(−t);Δ(+t)] Eq. 4

As an example, if warping belongs to a range (−2;2), five possible positions of ending point and each section (N) 205 is tested.

Referring to FIGS. 2D, and 2E, where Matrix F and U represent L_{R}=12; L_{T}=12; m=3 and t=1. All elements of Matrix F are initiated as minus infinity, except element f(N+1, L_{T}+1), which equals zero. During the optimization procedure, elements of Matrix F determined by boundary start value Jₛₜₐᵣₜ 230, and boundary end value J_{end} 235 for each section are replaced by a cumulative benefit function, constructed based on correlation coefficients of corresponding parts in target profile w_{T} and interpolated profile w_{R}′, where std(w) represents standard deviation and w̅ is the mean of vector w;

$$cc = \frac{( w T - \overline{w} T ) T ( {wR}^{′} - \overline{w} {R}^{′} )}{std ( wT ) std ( {wR}^{′} )} \qquad Eq . 5$$

The boundary values 230 and 235 are represented as;

Jₛₜₐᵣₜ=max[(i−1)(m+Δ−t);L_{T}−(N−i+1)(m+Δ+t)]+1 Eq. 6

J_{end}=min[(i−1)(m+Δ+t);L_{T}−(N−i+1)(m+Δ−t)]+1 Eq. 7
for i=(1, . . . ,N)

Correlation coefficient is calculated for each possible position of ending point f(i,j), varying all possible warping (u) in the range (−Δ (t); Δ (t)) and added to the value of the benefit function for previous ending point. Only the highest value of the cumulative correlation coefficient is kept in Matrix F. The path through Matrix F that maximizes the benefit function, as shown by the grey in FIG. 2D, is identified through dynamic programming.

Referring to FIG. 2E, where Matrix U represents corresponding values of warping (u). Matrix U starts from the last but one row of Matrix F and continues to the first row of Matrix F. When the value of the benefit function for the first point is calculated, all previous suboptimal solutions are known. Matrix U, of FIG. 2E, represents the reconstruction of the signal and contains optimal warping (u) for each section N.

In an exemplary embodiment, the invention may utilize a dynamic programming method for calculating and locating linear stretches combined with the matrix layout shown in FIGS. 2D and 2E. Such dynamic programming method may seek to increase the efficiency of calculation by solving each subproblem only once, thus reducing the number of computations: once the solution to a given subproblem has been computed, it may be reused for all same computations. This method may be useful when the number of repeating subproblems grow exponentially as a function of the size of the input.

Referring back to FIG. 1, as discussed previously, the signals from two measuring points 35 and 36 may be analyzed by the correlation optimized warping module 120 to determine the time delay (ΔT) between the measurements taken by the upstream sensing element 150 and the downstream sensing element 160, in accordance with the embodiment of the invention.

FIGS. 3A and 3B depict a graphical representation of reference signatures before and after alignment, in accordance with an embodiment of the present invention. Correlation optimized warping module 120 may analyze the signal data on the same time scale and identify corresponding substantially similar peaks within the signal data. To accomplish this, correlation optimized warping module 120 may obtain a target profile (t₁) 300 within signal data. After finding target profile (t₁) 300 and its retention times, correlation optimized warping module 120 may divide the target components into N sections. Each section where the numbered points achieve the highest intensity will be used for linear interpolation.

Corresponding unaligned profile (t₂) 305 may refer to signal data components which exhibit the same signal at a different retention time than a target profile (t₁) 300, in accordance with embodiments of the invention. As an example, FIG. 3A exhibits retention time of 0.5 seconds for a target profile (t₁) 300, and 1.5 seconds for the unaligned target profile (t₂) 305.

Correlation optimized warping module 120 may then shift the secondary unaligned profile's (t₂) 305 retention time by adjusting the column length to coincide with target profile (t₁) 300. As evidenced by FIG. 3B, the time shift 310 equals to 1 second, which correlates to time delay (ΔT) needed to calculate velocity of the fluid moving between measured points 35 and 36.

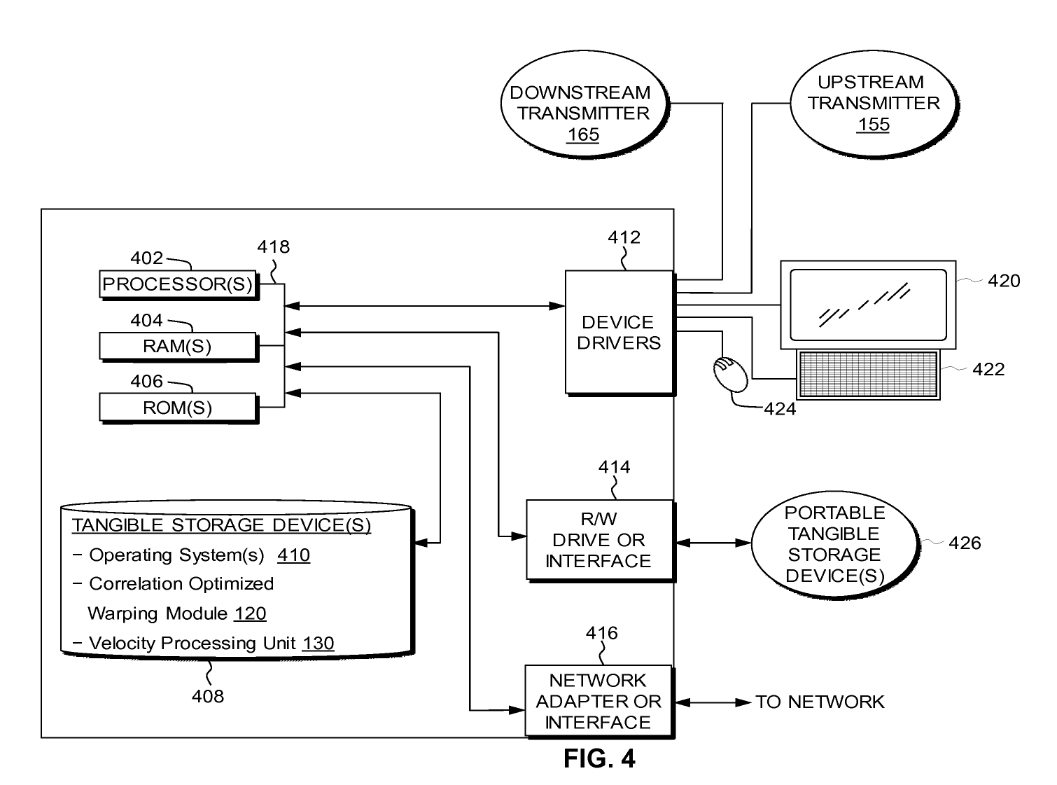

Referring back to FIG. 1, time delay (ΔT) calculated by correlation optimized warping module 120 is sent to velocity processing unit 130. Velocity processing unit 130 may then divide known distance (D) between the measured points 35 and 36 by the time delay (ΔT) to provide and output signal (not shown in drawing) to display screen 420 (FIG. 4), indicative of the velocity of the moving substance within pipe 30.

FIG. 4 depicts a block diagram of components of the control module 110 of velocity measurement system 199 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Control module 110 can include one or more processors 402, one or more computer-readable RAMs 404, one or more computer-readable ROMs 406, one or more tangible storage devices 408, device drivers 412, read/write drive or interface 414, and network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within a system.

One or more operating systems 410, correlation optimized warping module 120, and velocity processing unit 130 are stored on one or more of the computer-readable tangible storage devices 408 for execution by one or more of the processors 402 via one or more of the respective RAMs 404 (which typically include cache memory). In the illustrated embodiment, each of the computer-readable tangible storage devices 408 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Control module 110 can also include a R/W drive or interface 414 to read from and write to one or more portable computer-readable tangible storage devices 426. Correlation optimized warping module 120 and velocity processing unit 130 on control module 110 can be stored on one or more of the portable computer-readable tangible storage devices 426, read via the respective R/W drive or interface 414 and loaded into the respective computer-readable tangible storage device 408.

Control module 110 can also include a network adapter or interface 416, such as a TCP/IP adapter card or wireless communication adapter (such as a 4G wireless communication adapter using OFDMA technology). Correlation Optimized Warping Module 120 and velocity processing unit 130 on control module 110 can be downloaded to the computing device from an external computer or external storage device via a network (for example, the Internet, a local area network or other, wide area network or wireless network) and network adapter or interface 416. From the network adapter or interface 416, the programs are loaded into the computer-readable tangible storage device 408. The network may comprise copper wires, optical fibers, wireless transmission, routers, firewalls, switches, gateway computers and/or edge servers.

Control module 110 can also include a display screen 420, a keyboard or keypad 422, upstream transmitter 155, downstream transmitter 165 and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 can comprise hardware and software (stored in computer-readable tangible storage device 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Although preferred embodiments have been depicted and described in detail herein, it will be apparent to those skilled in the relevant art that various modifications, additions, substitutions and the like can be made without departing from the spirit of the invention, and these are, therefore, considered to be within the scope of the invention, as defined in the following claims.

What is claimed is:

1. A method for measuring velocity of a substance using data pattern characteristics, the method comprising:
receiving, by a processor, a first set of data, wherein the first set of data describes one or more characteristics of a portion of a substance in at least a first location;
receiving, by a processor, a second set of data, wherein the second set of data describes one or more characteristics of at least a part of the portion of the substance in at least a second location;
determining, by a processor, that the second set of data is substantially similar to the first set of data; and
determining, by a processor, a velocity of the substance based on the first set of data and the second set of data.

2. The method of claim 1, wherein determining that the second set of data is substantially similar to the first set of data further comprises:
calculating a time warping alignment of the first set of data and the second set of data using correlation optimized warping; and
determining a time delay based on the calculated time warping alignment.

3. The method of claim 2, wherein determining the velocity of the substance further comprises:
dividing a distance between the first location and the second location by the determined time delay value.

4. A method of claim 1, further comprising:
calculating, by a processor, a flow rate of the substance based on the velocity of the substance and a cross sectional area of a medium containing the substance.

5. A method of claim 1, wherein the first data set is received from the first location and a third location and the second data set is received from the second location and a fourth location.

6. A computer program product for measuring velocity of a substance using data pattern characteristics, comprising a tangible storage device having program code embodied therewith, the program code executable by a processor of a computer to perform a method comprising:
a computer readable storage media and program instructions stored on the computer readable storage media, the program instructions comprising:
program instructions to receive, by a processor, a first set of data, wherein the first set of data describes one or more characteristics of a portion of a substance in at least a first location;
program instructions to receive, by a processor, a second set of data, wherein the second set of data describes one or more characteristics of at least a part of the portion of the substance in at least a second location;
program instructions to determine, by a processor, that the second set of data is substantially similar to the first set of data; and
program instructions to determine, by a processor, a velocity of the substance based on the first set of data and the second set of data.

7. A computer program product in accordance with claim 6, wherein determining that second set of data is substantially similar to first set of data further comprises:
calculating a time warping alignment of the first set of data and the second set of data using correlation optimized warping; and
determining a time delay based on time warping alignment.

8. A computer program product in accordance with claim 7, wherein determining velocity comprises:
dividing a distance between the first location and the second location by the time delay value.

9. A computer program product in accordance with claim 6, further comprising:
calculating, by a processor, a flow rate based on the velocity and a cross sectional area of a medium containing the substance.

10. A computer program product of claim 6, wherein the first data set is received from the first location and a third location and the second data set is received from the second location and a fourth location.

11. A computer system for measuring velocity of a substance using data pattern characteristics, the computer system comprising:
one or more computer processors;
one or more computer readable storage media;
program instructions stored on the computer readable storage media for execution by at least one of the one or more processors, the program instructions comprising:
program instructions to receive, by a processor, a first set of data, wherein the first set of data describes one or more characteristics of a portion of a substance in at least a first location;
program instructions to receive, by a processors, a second set of data, wherein the second set of data one or more characteristics of at least a part of the portion of the substance in at least a second location;
program instructions to determine, by a processor, that the second set of data is substantially similar to the first set of data; and
program instructions to determine, by a processor, a velocity of the substance based on the first set of data and the second set of data.

12. A computer system in accordance with claim 11, wherein determining that second set of data is substantially similar to first set of data further comprises:
calculating a time warping alignment of the first set of data and the second set of data using correlation optimized warping; and
determining a time delay based on time warping alignment.

13. A computer system in accordance with claim 12, wherein determining velocity comprises:
dividing a distance between the first location and the second location by the time delay value.

14. A computer system in accordance with claim 11, further comprising:
calculating, by a processor, a flow rate based on the velocity and a cross sectional area of a medium containing the substance.

15. A computer system of claim 11, wherein the first data set is received from the first location and a third location and the second data set is received from the second location and a fourth location.
